(19) United States
(12) Patent Application Publication
(10) Pub. No.: US 2024/0246612 A1
(43) Pub. Date: Jul. 25, 2024

(54) SIDE-RAIL PARTITION AND MOTOR VEHICLE BODY EQUIPPED WITH SUCH A SIDE-RAIL PARTITION

(71) Applicant: PSA AUTOMOBILES SA, Poissy (FR)

(72) Inventors: Paul BORNIER, LUZE (FR); Stephane FONFREDE, BELFORT (FR); Tou THOR, PONT DE ROIDE VERMONDANS (FR)

(21) Appl. No.: 18/562,625

(22) PCT Filed: May 12, 2022
(86) PCT No.: PCT/FR2022/050906

§ 371 Date: Nov. 20, 2023

(30) Foreign Application Priority Data
Jun. 23, 2021 (FR) FR2106710

(51) Int. Cl. B62D 25/02; B62D 25/20

(52) U.S. Cl. CPC B62D 25/025; B62D 25/2036

(57) ABSTRACT

The invention relates to a side-rail partition (2) intended to be mounted in an inner side rail (1) of a motor vehicle body, said side-rail partition (2) being composed principally of a U-shaped component whose wings extend perpendicularly with respect to the web or central wall of said side-rail partition (2), characterized in that it additionally has at least one reinforcement wall extending from the central wall between the edges of the wings of the side-rail partition (2). Application to the reinforcement of a vehicle body against lateral impact.

### CROSS-REFERENCE TO RELATED APPLICATIONS

This application is the US National Stage under 35 USC § 371 of International Application No. PCT/FR2022/050906, filed May 12, 2022, which claims the priority of French application 2106710 filed on Jun. 23, 2021, the content (text, drawings and claims) of both said applications being incorporated by reference herein.

### BACKGROUND

The present devices described herein relate to a side-rail partition and a motor vehicle body equipped with such a side-rail partition.

In order to ensure the protection of the occupants during an accident, it is necessary to maintain the integrity of the structural elements of the body for the entire duration of the impact, to avoid breaking the load paths and ensure room for the occupants to survive.

It is in particular important to avoid physical rupture of the structural or packing parts, which could injure the occupants.

In addition, to add trim to the passenger compartment of the vehicle, orifices are generally provided on the structural elements to receive the fastening attachments made from plastic materials.

Thus, on the inner side rail, which is an important structural element, there is in particular a rectangular-shaped fastening orifice on the upper part of these inner side rails.

The rectangular shape of these fastening orifices generates, at the corners, concentrations of stress and deformation. It is therefore much easier for a crack to appear at the corner of a rectangular hole than in the solid sheet or around a circular hole. Such fastening orifices may constitute fragility points in the structure.

When such damage reaches the rectangular orifices or holes on the inner side rail, then a crack can be formed, which breaks the load path that is the inner side rail. This destabilizes the overall impact behavior and brings cracks into the passenger compartment that are likely to injure the occupants.

New barrier impact regulations have accentuated this phenomenon, as the crash test speed was increased by 20%.

To avoid the appearance of such cracks at rectangular holes, it is necessary to move the plastic deformation around the hole away or to eliminate it during the lateral impact.

Conventionally, the stiffness of the inner or outer side rail elements is generally increased by increasing their thickness. A problem localized at the hole is then resolved by a more comprehensive solution at the side rails, which reduces the stress over the entire inner side rail.

The increase in the thickness of the inner side rail greatly affects both the mass, the side rail being a profiled part of very large size, and the price and feasibility of the side rail and therefore does not represent a satisfactory solution from an economic point of view or from the point of view of the vehicle's mass; in fact this increase in mass automatically involves an increase in energy consumption and therefore CO₂ production, which goes against the current trend.

Another solution is to use an added component or patch against the inner side rail around the hole, so as to form a localized extra thickness that makes it possible to reinforce said side rail around this hole.

The addition of such an added component has a less unfavorable impact on the mass of the body, but the addition of a specific component is generally not desirable. Adding a component such as these patches therefore requires adding a mounting step and therefore adding spot welds, which automatically increases the cycle times and the length of the assembly line.

Moreover, it is known to add components at the inner side rail such as side-rail partitions that are placed on the side rail at the seat cross-members or middle base, which makes it possible to improve energy transfer during a lateral impact, in particular at the cross-members. Such side-rail partitions as described in CN-U-209096830 are generally in the form of a U-shaped part generally fastened to the inner side rail by the end of the wings of the U welded to the inner side rail so that said wings extend transversely into the inner side rail, forming a partition, and that the web of the U-shaped part extends substantially parallel to the inner side rail, separated therefrom.

### SUMMARY

The present description therefore proposes to produce a vehicle body that, being provided with fastening orifices at the inner side rail of rectangular shape, has improved resistance to the risks of plastic deformation around the rectangular orifices existing on the side-rail by using a side-rail partition of a new design.

The present devices therefore relate to a side-rail partition intended to be mounted in an inner side rail of a motor vehicle body, said side-rail partition consisting mainly of a U-shaped part whose wings extend perpendicularly with respect to the web or central wall of the side-rail partition, characterized in that it additionally has at least one reinforcement wall extending from the central wall between the edges of the wings of the side-rail partition.

An inner side rail is generally a profile, the cross section of which has a U-shape, preferably with slightly flared wings of the U, the side rail thus having a central wall (web) and two upper and lower walls (wings of the U). Insofar as the wings of the side-rail partition are intended to extend transversely into the side rail, they have a shape corresponding to the cross-section of the side rail. Thus, the edges of said wings of the side-rail partition extend along the wings of the side rail. Thus, advantageously, a reinforcement wall of the side-rail partition that extends from the central part between the edges of the wings of the side rail then also extends against a wall of the side rail consisting of a wing of the side-rail profile.

Preferably, the side-rail partition has two reinforcement walls, thus giving the side-rail partition a box shape with a bottom made up of the central wall of the side-rail partition and side walls consisting of the wings of the side rail and the reinforcement walls.

Thus, this box-shaped connecting partition is intended to be attached with its bottom against the central wall of the side rail profile, the side walls made up of the wings of the side-rail being intended to extend transversely in the inner side rail to transmit the forces of a lateral impact while the reinforcement walls extend against the upper and lower walls of the side-rail profile.

According to a preferred embodiment, the side-rail partition can be obtained by cutting a metal blank in the form of a cross having at least three branches around a central part, said branches being bent by bending around the central part of the blank constituting the central part of the side-rail partition in order to form, for some, the wings of the side-rail partition, and for the others, the reinforcement walls.

Advantageously, the branches of the blank comprise protruding parts then enabling their fastening to the other branches, for example by welding.

Thus, according to a preferred variant, the metal blank is cut in the form of a cross with four branches, the arms of which are folded down to form, for some, the wings of the side-rail partition, and for the others, the reinforcement walls. The branches of the blank forming the reinforcement walls preferably comprise protruding parts then enabling their fastening to the other two branches. In one variant, the protruding parts can be provided on the branches forming the wings of the side-rail partition.

The side-rail partition is therefore easily obtained by cutting and bending the parts relative to one another. Cut-outs can be provided in at least one of the reinforcement parts to form a hole positioned in correspondence with a fastening orifice of the side rail during the installation of the side-rail partition on the inner side rail. Additional holes or recesses can be made to lighten the part forming the side-rail partition.

It is thus possible to propose a side-rail partition fulfilling both its function of transmission of forces during a lateral impact toward the cross-member opposite of which it is mounted on the inner side rail and a new function of reinforcing the inner side rail when the latter has a fastening orifice of rectangular shape provided in the vicinity of the installation location on the inner side rail of the side-rail partition.

The described devices therefore also relate to a motor vehicle body, the lower part of which comprises:
a floor,
two inner side rails respectively made up of a U-shaped profiled element whose web or central wall is fixed along a longitudinal side of the floor, the wings of the U-shaped profile defining an upper wall and a lower wall of the inner side rail, said lower and upper walls being able to have fastening orifices of rectangular shape,
cross-members for bearing seats extending transversely on the floor between the inner side rails, and
a side rail partition mounted in an inner side rail at each cross-member, mainly consisting of a U-shaped part, the wings of which extend perpendicularly to the central web or wall of the side-rail partition, said side-rail partition being mounted on the inner side rail so that the wings of said side-rail partition extend transversely into the inner side rail, between the lower and upper walls of said inner side rail and perpendicular to the central wall and to said upper and lower walls of said inner side rail, characterized in that the side-rail partition is a side-rail partition that has at least one reinforcement wall extending transversely between the bottom and top walls of the side rail, said side-rail partition being mounted in the inner side rail with its central wall fixed to the central wall of the inner side rail, the wings of the side-rail partition extending transversely between the lower and upper walls of the inner side rail while the at least one reinforcement wall of the side-rail partition extends against an upper or lower wall of the inner side rail and is fixed thereto, and, when said upper and/or lower wall of the inner side rail has a fastening orifice, said reinforcement wall has a hole of complementary shape and dimensions to said fastening orifice.

Thus, advantageously, the reinforcement wall of the side rail extends along the upper or lower wall of the inner side rail and, when the latter comprises a fastening orifice of rectangular shape, the lateral wall provided with a hole with a complementary shape and fastened to said upper or lower wall reinforces the inner side rail against the risks of cracks at this fastening orifice, during a lateral impact.

A side rail partition is attached to the inner side rail by welding the central part of the side-rail partition to the central part of the inner side rail and the at least one reinforcement wall on the upper or lower wall of the inner side rail.

Thus, the side-rail partition performs its usual role in transferring forces during a lateral impact towards the cross-members and also makes it possible to reinforce the inner side rail at a weak point consisting of this fastening orifice of rectangular shape. Thus, using a single part, the side-rail partition, two distinct functions are fulfilled, which limits manufacturing costs by mounting a single part instead of two and thus limiting the time cycle and the length of the assembly line.

The lower part of the motor vehicle body thus has greatly improved lateral shock resistance properties allowing it to adhere to stricter regulations and, at a limited cost.

The described devices also relate to a motor vehicle comprising a body.

### BRIEF DESCRIPTION OF THE FIGURES

The described devices will now be described in more detail with reference to the figures.

FIG. 1 is a perspective top view of the floor of a body.

FIG. 2 is a lateral perspective view of an inner side rail equipped with a side-rail partition.

FIG. 3 is an exploded lateral perspective view of a side rail 1 and a side-rail partition.

FIG. 4 is a schematic view of a metal blank to form a side-rail partition.

FIG. 5 is a perspective bottom view of the side rail of FIG. 2.

FIG. 6 is a sectional view of the side rail of FIG. 2.

### DETAILED DESCRIPTION

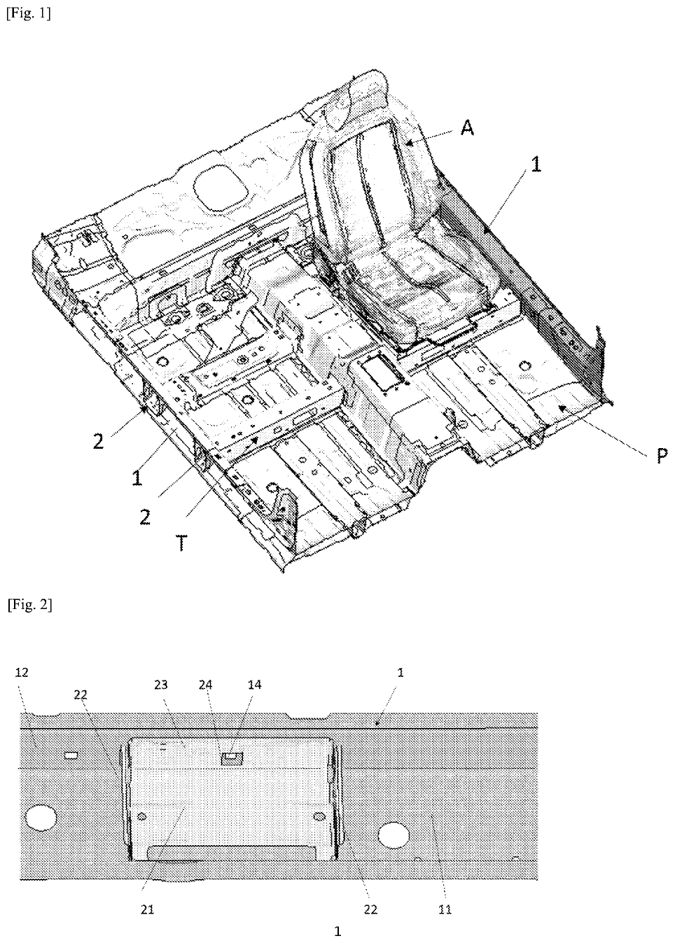

As can be seen in FIG. 1, the lower part of a motor vehicle body comprises a floor P, provided on its lateral sides of inner side rails 1, and of cross-members T extending over the floor P between the side rails 1, in particular at the seats A.

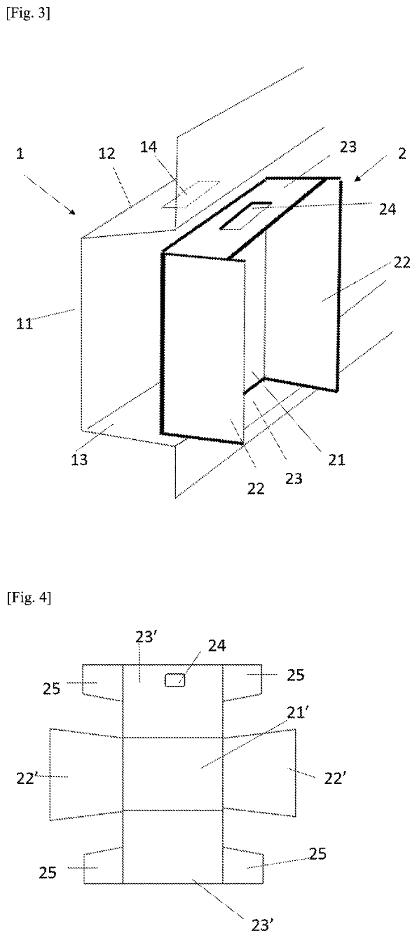

As can be seen in FIGS. 2 and 3, the inner side rail 1 consists of a profile, the section of which is mainly U-shaped. The web or central wall 11 of the side rail 1 is intended to be mounted against the floor P and the wings of the inner side rail profile 1 form an upper wall 12 and a lower wall 13 wherein are provided orifices 14 for fastening parts, in particular rectangular orifices which allow the fastening and placement of body accessories, for example threshold linings.

These orifices 14 due to their rectangular shape have a risk of cracks at the corners of the orifice 14 during a lateral impact and must if possible be reinforced.

The side-rail partitions 2 are attached inside the side rail 1 at the cross-members T. These partitions 2 are in the form of a U-shaped part, with a web or central part 21, and two wings 22. Such a partition 2 is placed on the side rail 1 so that the central part 21 is attached with pressing onto the central part 11 of the side rail and the wings 22 extend transversely in the side rail 1 bearing against the central wall 11 and against the upper 12 and lower 13 walls of the inner side rail 1.

Thus, a lateral impact occurring on the body is transmitted via the side-rail partition 2 to the cross-member T as a match through the side rail 1.

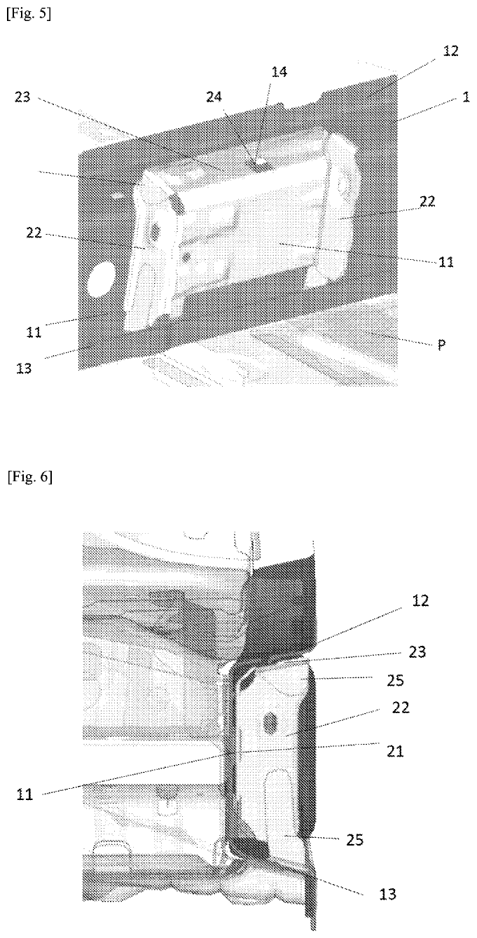

When at the location of the side rail 2, the upper wall 12 of the inner side rail 1, for example, comprises a rectangular orifice 14 for fastening, the side rail 2 is shaped to comprise a reinforcement wall 23 extending from the central part 21 and between the edges of the wings 22, preferably on each side of the central wall 21. These two walls 23 form, with the central part 21 and the wings 22, a sort of open box as can be seen in FIGS. 3 and 5 which is mounted in the inner side rail 1.

Preferably, the side-rail partition 2 is obtained by cutting a metal blank 2′ in the form of a cross with four branches 22′, 23′ around a central part 21′ as can be seen in FIG. 4, the branches 22′, 23′ of which, folded by bending around the central part 23′ constituting the central part 21 of the side-rail partition 2, form for some the wings 22 of the side-rail partition 2 and for the others the reinforcement walls 23. The branches 23′ of the blank 2′ forming the reinforcement walls 23 preferably comprise protruding parts 25 then enabling their fastening to the two branches 22′. Alternatively, the protruding parts 25 can be provided on the branches 22′.

The shape of the branches 22′ is defined as a match for the cross-section of the profile of the inner side rail 1, which in the example shown corresponds to a cross-section of a U-shaped profile whose wings are flared.

The side rail 2 is obtained by bending the parts 21′, 22′ and 23′ relative to one another. Cut-outs can be provided, at least one of which makes it possible to form a hole 24 which is positioned as a match a fastening orifice 14 of the side rail 1 during the installation on the inner side rail 1. Holes or recesses can be made to lighten the part forming the partition 2.

The side-rail partition 2 can then be mounted on the side rail 1 with its central part 21 fastened, for example by welding points, bearing against the central wall 11 of the side rail 1, see FIGS. 6 and 7. The wings 22 of the side rail 2 then extend transversely between the upper 12 and lower 13 walls of the side rail 1 while the reinforcement walls 23 extend along the upper wall 12 and the lower wall 13 of the side rail 1. Each reinforcement wall 23 bearing against a wall 12, 13 of the side-rail profile can be easily fastened thereto by spot welds.

The wall 23 extending against the upper wall 12 furthermore has a hole 24 with a shape and dimensions complementary to those of the fastening orifice 14 of the upper wall 12 so that, when the side-rail partition 2 is placed, the hole 24 in the wall 23 is positioned as a match for an orifice 14 of the side rail 1 (see FIGS. 2 and 5).

The partition 2 is attached to the side rail 1 by welding points at its central part 21 and its reinforcement walls 23. Thus, the reinforcement wall 23 welded to the upper wall 12 of the side rail 1 makes it possible to reinforce said side rail 1 at the orifice 14 by increasing the thickness at this orifice 14, which locally increases the stiffness of the inner side rail 1.

Advantageously, the side-rail partition 2 fulfills its role of a partition enabling the transmission of forces toward the cross-members T in the event of a lateral impact and also makes it possible to reinforce the side rail 1 in a specific manner at fastening orifices provided in the side rail 1 and in the vicinity.

1. A side-rail partition intended to be mounted in an inner side rail of a motor vehicle body, said side-rail partition consisting mainly of a U-shaped part whose wings extend perpendicularly with respect to the web or central wall of the side-rail partition, wherein it additionally has at least one reinforcement wall extending from the central wall between the edges of the wings of the side-rail partition.

2. The side-rail partition according to claim 1, wherein the side-rail partition has two reinforcement walls, thus conferring on the partition a box shape with a bottom consisting of the central wall of the side-rail partition, side-rail partitions consisting of the wings of the side-rail partition and the reinforcement walls.

3. The side-rail partition according to claim 1, wherein it is obtained by cutting a metal blank in the form of a cross having at least three branches around a central part, said branches being folded by folding around the central part of the blank constituting the central part of the side-rail partition to form for some the wings of the side-rail partition and for the others the reinforcement walls.

4. The side-rail partition according to claim 3, wherein the branches of the blank comprise protruding parts then enabling their fastening to the other two branches.

5. A motor vehicle shell, the lower part of which comprises:
a floor,
two inner side rails respectively consisting of a U-shaped profiled element whose web or central wall is fixed along a longitudinal side of the floor, the wings of the U-shaped profile defining an upper wall and a lower wall of the inner side rail, said lower and upper walls being able to have fastening orifices of rectangular shape,
cross-members for carrying seats extending transversely on the floor between the inner side rails, and a side rail mounted in an inner side rail at each cross-member, consisting mainly of a U-shaped part whose wings extend perpendicularly to the web or central wall of the side-rail partition, said side-rail partition being mounted on the inner side rail so that the wings of said U-shaped part extend transversely into the inner side rail, between the lower and upper walls of said inner side rail and perpendicular to the central part and to said upper and lower walls of said inner side rail, wherein the side-rail partition is a side-rail partition according to claim 1, said side-rail partition being mounted in the inner side rail with its central wall bearing against the central wall of the inner side rail, the wings of the side-rail partition extending transversely between the lower and upper walls of the inner side rail while the at least one reinforcement wall of the side-rail partition extends against an upper or lower wall of the inner side rail and, when said top and/or bottom wall of the inner side rail has a fastening orifice, said reinforcement wall has a hole of complementary shape and dimensions to said fastening orifice.

6. The motor vehicle body shell according to claim 5, wherein the side rail is attached to the inner side rail by welding the central part of the side-rail partition to the central part of the inner beam and the at least one reinforcement wall on the upper or lower wall of the inner side rail.

7. A motor vehicle comprising a motor vehicle body according to claim 5.
